(19) United States
(12) Patent Application Publication
(10) Pub. No.: US 2013/0153389 A1
(43) Pub. Date: Jun. 20, 2013

(54) BUTTON APPARATUS

(71) Applicant: HUA ZHANG, Shenzhen City (CN)

(72) Inventor: HUA ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/483,230

(22) Filed: May 30, 2012

(30) Foreign Application Priority Data
Dec. 16, 2011 (CN) 201110423194.2

(51) Int. Cl. H01H 13/02

(52) U.S. Cl. 200/520; 200/341

(57) ABSTRACT

A button apparatus includes a decorating plate, and a button device attached to the decorating plate. The button device includes a securing member, a button attached to the securing member, and at least two securing arms attached to the decorating plate. The button extends through the decorating plate and is located on a top surface of the decorating plate, and the securing plate is located on a bottom surface of the decorating plate. The at least two securing arms evenly extend from an outer edge of the securing member, and the button is resiliently moveable perpendicular to the decorating plate, to deform the at least two securing arms and operate an electrical switch.

### BACKGROUND

1. Technical Field

The present disclosure relates to button apparatuses, more particularly to a button apparatus for a computer.

2. Description of Related Art

Decorating plates and a plurality of button devices attached on the decorating plate, such as a power button device and a voice button device can be found on many computers. A button device may include a securing panel, a button attached to the securing panel, an extending arm and a rib. The button is secured to the decorating plate by a hot melt process, and the rib is connected to the button by the extending arm. In use, when the button is pressed, the extending arm is deformed to move the rib to open or close an electrical connection. However, the button is controlled by the extending arm, and when the extending arm fails to release completely, the button cannot move back. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a button apparatus in accordance with an embodiment.

FIG. 2 is assembled view of the button apparatus of FIG. 1.

FIG. 3 is a cross-sectional view of the button apparatus of FIG. 2, taken along a line III-III.

FIG. 4 is an exploded, isometric view of a button apparatus in accordance with another embodiment.

FIG. 5 is an assembled view of the button apparatus of FIG. 4.

FIG. 6 is a cross-sectional view of the button apparatus of FIG. 5, taken along a line V-V.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

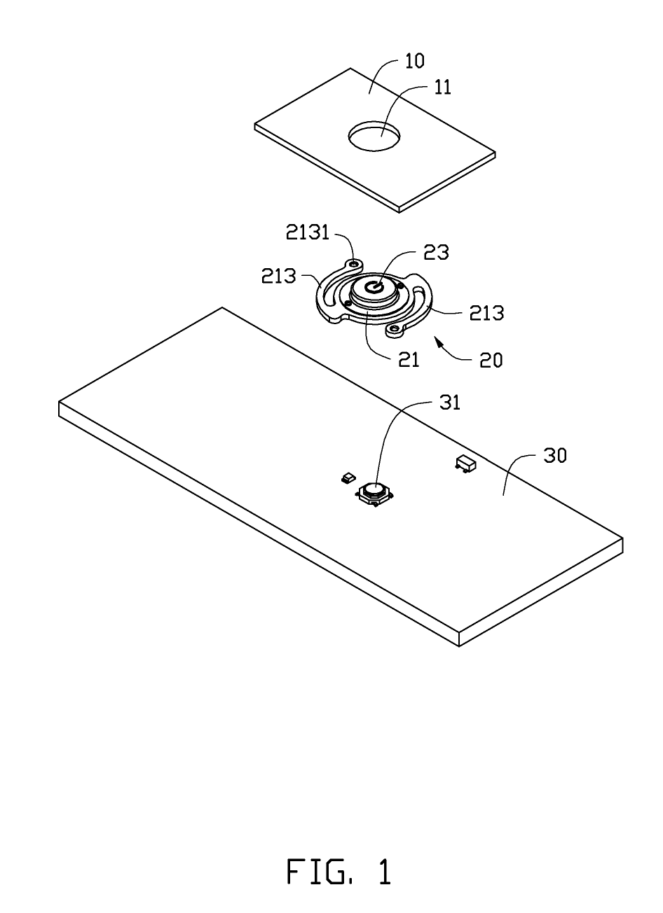

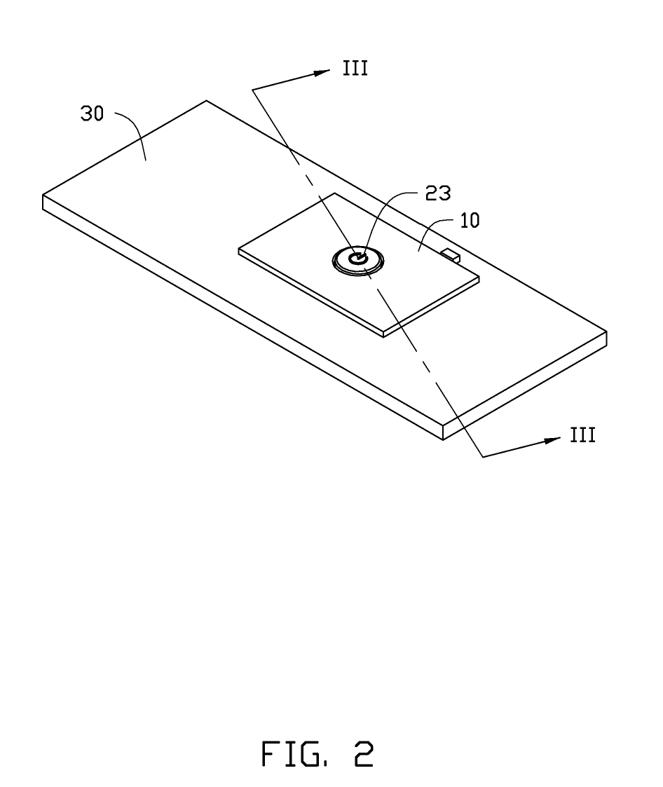

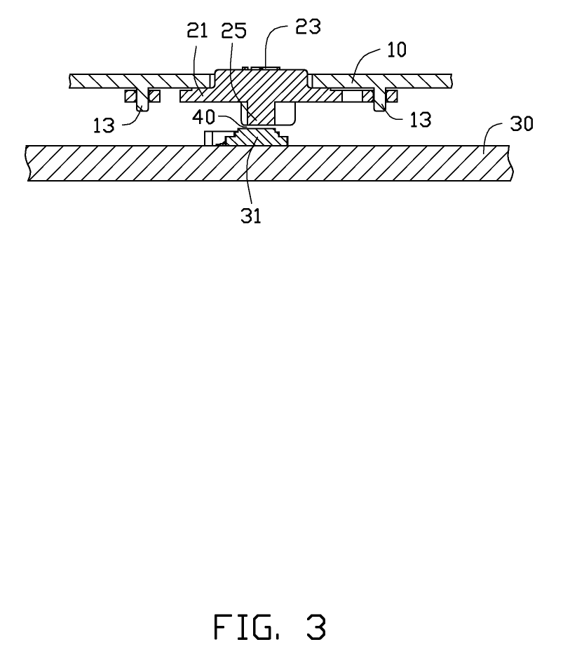

Referring to FIGS. 1-3, a button apparatus in accordance with an embodiment includes a first decorating plate 10, a first button device 20 attached to the first decorating plate 10, and a first circuit board 30 engaged with the first button device 20. The first circuit board 30 is electronically connected to a first power switch 31. In one embodiment, the first decorating plate 10 may be a plate that is attached to a front of a computer case.

The first decorating plate 10 defines a first through hole 11 and two first securing posts 13. The two first securing posts 13 are located around the first through hole 11 and diametrically opposed, the first through hole 11 being round.

The first button device 20 includes a first securing member 21, a first button 23 attached to a top surface of the first securing member 21, and a first driving portion 25 attached to a bottom surface of the first securing member 21. The first driving portion 25 is substantially perpendicular to the first securing member 21. The first button 23 is round, and a diameter of the first button 23 is less than a diameter of the first through hole 11.

Two first securing arms 213 extend from an outer edge of the first securing member 21. In one embodiment, the two first securing arms 213 and the first securing member 21 are coplanar. Each of the two first securing arms 213 is resilient and deformable, and a first securing hole 2131 is defined in a free end of each of the two first securing arms 213. In one embodiment, the first securing member 21 is round, and the two first securing arms 213 are equal in length. The two first securing arms 213 are evenly arranged at the outer edge of the first securing member 21. Each of the two first securing arms 213 is arc. The first button 23 is a round. The arc, where each of the at least two first securing arms 213 located, and the round, where the first button 23 located, are concentric. An extending direction of each of the two first securing arms 213 is the same, and in one embodiment, the extending direction is clockwise seen from above the button.

In assembly, the first button device 20 is placed on the bottom surface of the first decorating plate 10. The two first securing posts 13 are engaged in the two first securing holes 2131, to secure the two securing arms 213 to the first decorating plate 10. At this stage, the first button 23 extends through the first decorating plate 10 and is located on the top surface of the first decorating plate 10. The first driving portion 25 is aligned with the first power switch 31, and a first gap 40 is defined between the first driving portion 25 and the first power switch 31.

In use, the first button 23 is pressed to move the first securing member 21 in a first direction towards to the first circuit board 30, to deform the two first securing arms 213. Thus, the first driving portion 25 impacts on the first power switch 31, to open or close a power switch. After the first power switch 31 is opened or closed, the two first securing arms 213 are released, to restore the first button 23 to stand proud on the top surface of the first securing member 21.

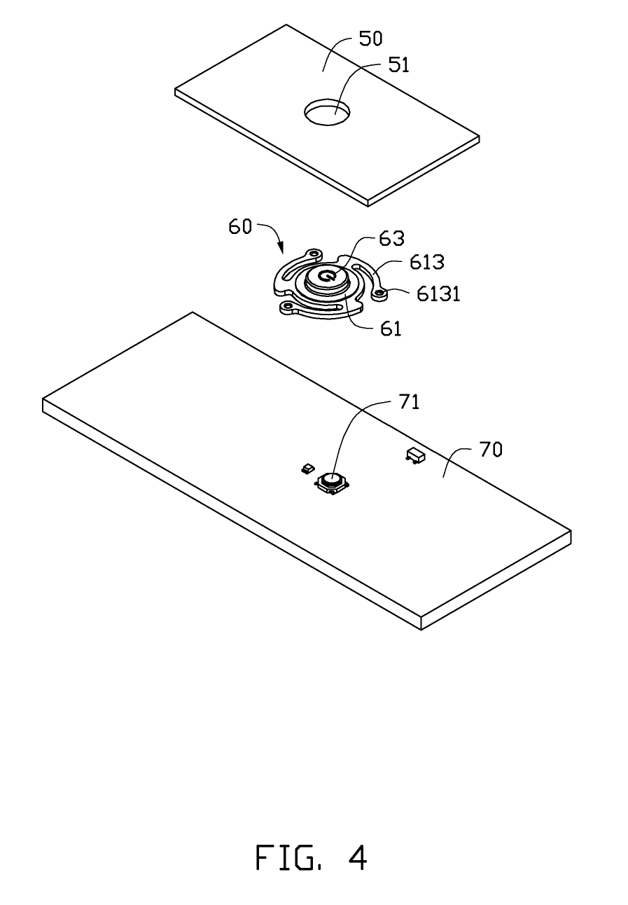

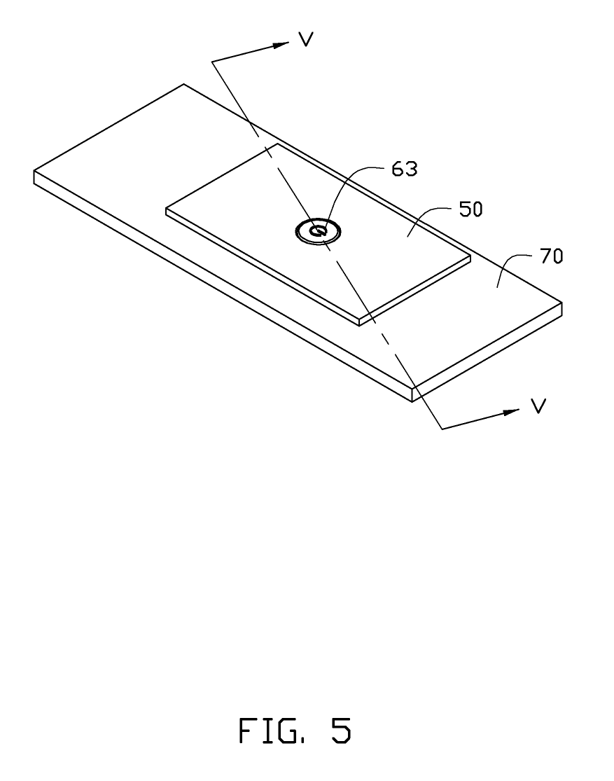

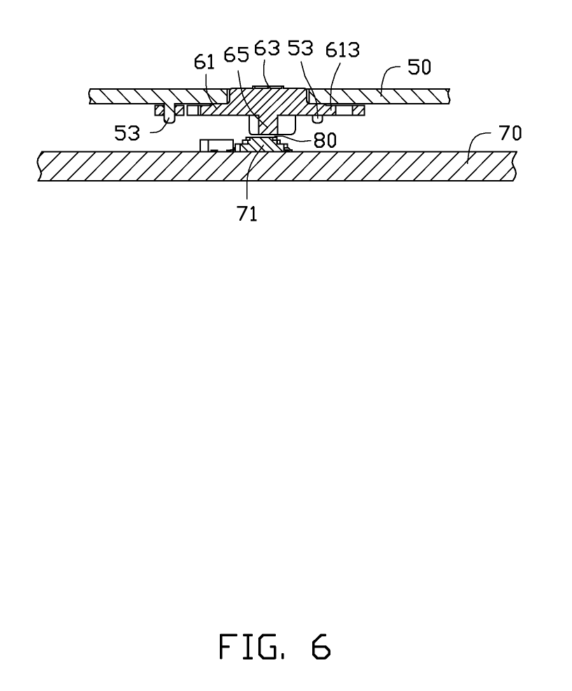

Referring to FIGS. 4-6, a button apparatus in accordance with another embodiment includes a second decorating plate 50, a second button device 60 attached to the second decorating plate 50, and a second circuit board 70 engaged with the second button device 60. The second circuit board 70 is electronically connected to a second power switch 71. In one embodiment, the second decorating plate 50 may be a plate that is attached to a front of a computer case.

The second decorating plate 50 has a same configuration to the first decorating plate 10, and defines a second through hole 51. Three second securing posts 53, around the second through hole 51, are located on the second decorating plate 50.

The second button device 60 includes a second securing member 61, a second button 63 attached to a top surface of the second securing member 61, and a second driving portion 65 attached to a bottom surface of the second securing member 61. The second driving portion 65 is substantially perpendicular to the second securing member 61. The second button 63 is round, and a diameter of the second button 63 is less than a diameter of the second through hole 51.

Three second securing arms 613 extend from an outer edge of the second securing member 61. In one embodiment, the three second securing arms 613 and the second securing member 61 are coplanar. Each of the three second securing arms 613 is resilient and deformable, and a second securing hole 6131 is defined in a free end of each of the three second securing arms 613. In one embodiment, the second securing member 61 is round, and a length of each of the three second securing arms 613 is equal. The three second securing arms 613 are evenly arranged at the outer edge of the second securing member 61. Each of the three second securing arms 613 describes an arc of a radius originating at the center of the second button 63. Each of the three second securing arms 613 has the same clockwise extending direction.

In assembly, the second button device 60 is placed on the bottom surface of the second decorating plate 50. The three second securing posts 53 are engaged in the three second securing holes 6131, to secure the three second securing arms 613 to the second decorating plate 50. At this stage, the second button 63 extends through the second decorating plate 50 and is located on the top surface of the second decorating plate 50, and stands proud of the top surface. The second driving portion 65 is aligned with the second power switch 71, and a second gap 80 is defined between the second driving portion 65 and the second power switch 71.

In use, the second button 63 is pressed to move the second securing member 61 towards to the second circuit board 70, to deform the three second securing arms 613. Thus, the second driving portion 65 can impact on the second power switch 71, to open or close a power switch of the computer. After the second power switch 71 is opened or closed, the three second securing arms 613 move the second securing member 61 back, until the second button 63 is again located on the top surface of the second securing member 61.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A button apparatus comprising:
a decorating plate;
a button device, attached to the decorating plate, comprising a securing member, a button attached to the securing member, and at least two securing arms attached to the decorating plate, the button extending through the decorating plate and being located on a top surface of the decorating plate, and the securing member being located on a bottom surface of the decorating plate;
wherein each of the at least two securing arms extends from an outer edge of the securing member, the button is moveable in a direction substantially perpendicular to the decorating plate, and the button is configured to deform each of the at least two securing arms.

2. The button apparatus of claim 1, wherein each of the at least two securing arms is arc, the securing member is a circular plate, and the arc of each of the at least two first securing arms and the circular plate are concentric.

3. The button apparatus of claim 1, wherein an extending direction of each of the at least two securing arms is same.

4. The button apparatus of claim 1, wherein the decorating plate defines a through hole for the button extending through, the through hole is round, and a diameter of the through hole is greater than a diameter of the button.

5. The button apparatus of claim 4, wherein each of the at least two securing arms comprises two securing arms having a same configuration, each of the at least two securing arms defines a securing hole, the decorating plate comprises two securing posts around the through hole, and each of the two securing posts is engaged in the securing hole.

6. The button apparatus of claim 5, wherein a straight line connecting between the two securing posts extends through a center of the through hole.

7. The button apparatus of claim 1, wherein the securing member further comprises a driving portion, and the driving portion is substantially perpendicular to the securing member.

8. A button apparatus comprising:
a decorating plate;
a button device, attached to the decorating plate, comprising a securing member, a button attached to the securing member, and at least two securing arms attached to the decorating plate; the securing member comprises a driving portion; the button extends through the decorating plate and is located on a top surface of the decorating plate; and the securing plate is located on a bottom surface of the decorating plate; and
a circuit board electronically connected to a power switch;
wherein the at least two securing arms evenly extend from an outer edge of the securing member, and the button is moveable relative to the securing member between a first position and a second position; in the first position, a gap is defined between the driving portion and the power switch; in the second position, each of the at least two securing arms is deformed, and the driving portion abuts the power switch.

9. The button apparatus of claim 8, wherein each of the at least two securing arms defines an arc of a radius originating at a center of the button.

10. The button apparatus of claim 9, wherein the securing member is a circular plate, and the arc of each of the two first securing arms and the circular plate are concentric.

11. The button apparatus of claim 9, wherein an extending direction of each of the at least two securing arms is same.

12. The button apparatus of claim 8, wherein the decorating plate defines a through hole for the button extending through, the through hole is round, and a diameter of the through hole is greater than a diameter of the button.

13. The button apparatus of claim 12, wherein each of the at least two securing arms comprises two securing arms having a same configuration, each of the at least two securing arms defines a securing hole, the decorating plate comprises two securing posts around the through hole, and each of the two securing posts is engaged in the securing hole.

14. The button apparatus of claim 13, wherein a straight line connecting between the two securing posts extends through a center of the through hole.

15. The button apparatus of claim 8, wherein the driving portion is substantially perpendicular to the securing member.
